(19) United States
(12) Patent Application Publication
(10) Pub. No.: US 2014/0237254 A1
(43) Pub. Date: Aug. 21, 2014

(54) CRYPTOGRAPHIC DEVICES AND METHODS FOR GENERATING AND VERIFYING LINEARLY HOMOMORPHIC STRUCTURE-PRESERVING SIGNATURES

(71) Applicant: THOMSON LICENSING, Issy de Moulineaux (FR)

(72) Inventors: Marc JOYE, Fougeres (FR); Benoit LIBERT, Cesson-Sevigne (FR)

(73) Assignee: THOMSON LICENSING, Issy de Moulineaux (FR)

(21) Appl. No.: 14/179,738

(22) Filed: Feb. 13, 2014

(30) Foreign Application Priority Data
Feb. 15, 2013 (EP) 13305176.3
Mar. 26, 2013 (EP) 13305371.0

(51) Int. Cl. H04L 9/32

(52) U.S. Cl. CPC H04L 9/3247
USPC 713/176; 713/180

(57) ABSTRACT

Generation of linearly homomorphic structure-preserving signature σ on a vector (M₁, . . . , Mₙ)∈ ⁿ by computing, in a processor, using a signing key sk={χᵢ, γᵢ, δᵢ}ᵢ₌₁ⁿ, signature elements (z, r, u) by calculating

$$z = {\prod }_{i = 1}^{n} {M}_{i}^{- {χ}_{i} } , r = {\prod }_{i = 1}^{n} {M}_{i}^{- {γ}_{i}} , u = {\prod }_{i = 1}^{n} {M}_{i}^{- {δ}_{i}} ,$$

and outputting the signature σ comprising the signature elements (z, r, u). The signature is verified by verifying, in a processor that (M₁, . . . , Mₙ)≠( , . . . , ) and that (z, r, u) satisfy the equalities =e(g_{z}, z)·e(gᵣ, r)·Πᵢ₌₁ⁿe(gᵢ, Mᵢ), =e(h_{z}, z)·e(h, u)·Πᵢ₌₁ⁿe (hᵢ, Mᵢ); and determining that the signature has been successfully verified in case the verifications are successful and that the signature has not been successfully verified otherwise. Also provided are a fully-fledged scheme and a context-hiding scheme.

### TECHNICAL FIELD

The present invention relates generally to cryptography, and in particular to linearly homomorphic structure-preserving signatures.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Linearly homomorphic signatures are well known in the art of cryptography. A definition is given in D. Boneh, D. Freeman, J. Katz, B. Waters. Signing a Linear Subspace: Signature Schemes for Network Coding. In PKC'09, Lecture Notes in Computer Science 5443, pp. 68-87, 2009.

Other examples of linearly homomorphic signatures are available in:
U.S. Pat. No. 7,743,253, issued Jun. 22, 2010; D.-X. Charles, K. Jain, K. Lauter. Digital signature for network coding.
D. Boneh, D. Freeman, J. Katz, B. Waters. Signing a Linear Subspace: Signature Schemes for Network Coding. In PKC'09, Lecture Notes in Computer Science, vol. 5443, pp. 68-87, 2009.
R. Gennaro, J. Katz, H. Krawczyk, T. Rabin. Secure Network Coding over the Integers. In PKC'10, Lecture Notes in Computer Science, vol. 6056, pp. 142-160, 2010.
N. Attrapadung, B. Libert. Homomorphic Network Coding Signatures in the Standard Model. In PKC'11, Lecture Notes in Computer Science, vol. 6571, pp. 17-34, 2011.
D. Boneh, D. Freeman. Linearly Homomorphic Signatures over Binary Fields and New Tools for Lattice-Based Signatures. In PKC'11, Lecture Notes in Computer Science, vol. 6571, pp. 1-16, 2011.
D. Boneh, D. Freeman. Homomorphic Signatures for Polynomial Functions. In Eurocrypt'11, Lecture Notes in Computer Science, vol. 6632, pp. 149-168, 2011.
D. Freeman. Improved security for linearly homomorphic signatures: A generic framework. In PKC'12, Lecture Notes in Computer Science, vol. 7293, pp. 697-714, 2012.
D. Catalano, D. Fiore, B. Warinschi. Adaptive Pseudo-free Groups and Applications. In Eurocrypt'11, Lecture Notes in Computer Science, vol. 6632, pp. 207-223, 2011.
D. Catalano, D. Fiore, B. Warinschi. Efficient Network Coding Signatures in the Standard Model. In PKC'12, Lecture Notes in Computer Science, vol. 7293, pp. 680-696, 2012.

It would appear that among the schemes proven secure in the standard model under standard assumptions the most efficient scheme is the one in N. Attrapadung, B. Libert, T. Peters. Computing on Authenticated Data: New Privacy Definitions and Constructions. In Asiacrypt'12, LNCS 7658, pp. 367-385, 2012.

The construction is homomorphic over the additive group ( ₚ, +). Namely, the underlying cyclic group is = ₚ and messages being signed consist of a file identifier τ∈{0,1}^{L} and a vector of ₚⁿ. The scheme makes use of a bilinear map e: × → _{T} defined between groups ( _{T}) of prime order p.

Keygen(λ, n): given a security parameter λ∈ and an integer n∈poly(λ) denoting the dimension of vectors to be signed, choose bilinear groups ( _{T}) of prime order p>2^{λ}. Choose

$$α {←}^{ R } {ℤ}_{p} , \hat{g} {←}^{ R } \hat{𝔾} , v {←}^{ R } 𝔾 and {u}_{0} , {u}_{1} , … , {u}_{L} ← 𝔾$$

for some L∈poly(λ). These elements (u₀, u₁, . . . , u_{L})∈ ^{L+1} will be used to implement a number theoretic hash function : {0,1}^{L}→ such that any L-bit string m=m[1] . . . m[L]∈{0,1}^{L} has a hash value (m)=u₀·Πᵢ₌₁^{L}uᵢ^{m[i]}. Pick

$${g}_{i} {←}^{ R } 𝔾$$

for i=1 to n. Finally, define the identifier space :={0,1}^{L}. The private key is sk:=α and the public key consists of

pk:=(( , _{T}),ĝ,ĝ^{α},v,{gᵢ}ᵢ₌₁ⁿ,{uᵢ}ᵢ₌₀^{L}).

Sign(sk, τ, \vec{v})): given a vector \vec{v}=(v₁, . . . vₙ)∈ ₚⁿ, a file identifier τ:={0,1}^{L} and the private key sk=α∈ ₚ, choose

$$r , s {←}^{ R } {ℤ}_{p} .$$

Then, compute a signature σ=(σ₁, σ₂, s)∈ × × ₚ as

$${σ}_{1} = {( {g}_{1}^{{v}_{1}} … {g}_{n}^{{v}_{n}} \cdot {v}^{s} )}^{α} \cdot {{H}_{𝔾} ( τ )}^{r} , {σ}_{2} = {\hat{g}}^{r} .$$

### SignDerive

$$( pk , τ , {\{ ( {β}_{i} , {σ}^{( i )} ) \}}_{i = 1}^{𝓁} ) \text{:}$$

given pk, a file identifier τ and l tuples (βᵢ, σ⁽ⁱ⁾), parse each σ⁽ⁱ⁾ as σ⁽ⁱ⁾ (σ_{i,1}, σ_{i,2}, sᵢ) for =1 to l. Choose

$$\tilde{r} {←}^{ R } {ℤ}_{p} .$$

Then, compute and output (σ₁, σ₂, s), where

$${σ}_{1} = {\prod }_{i = 1}^{𝓁} {σ}_{i , 1}^{{β}_{i}} \cdot {{H}_{𝔾} ( τ )}^{\tilde{r}} {σ}_{2} = {\prod }_{i = 1}^{𝓁} {σ}_{i , 2}^{{β}_{i}} \cdot {\hat{g}}^{\tilde{r}} s = {\sum }_{i = 1}^{𝓁} {β}_{i} \cdot {s}_{i}$$

Verify(pk, τ, \vec{γ}, σ): given pk, a signature σ=(σ₁, σ₂, s) and a message (τ, \vec{γ}), where τ∈{0,1}^{L} and \vec{γ}=(γ₁, . . . , γₙ)∈( ₚ)ⁿ, return ⊥ if \vec{γ}=\vec{0}. Otherwise, return 1 if and only if

e(σ₁,ĝ)=e(g₁^{γ}^{₁} . . . gₙ^{γ}^{_{n·v}}^{s},ĝ^{α})·e( (τ),σ₂).

It will be appreciated that in the construction, signatures on the all-zero vector \vec{0} are not allowed. This is not a restriction since, in all applications of linearly homomorphic signatures, a unit vector (0, . . . , 1, . . . , 0) of appropriate length is appended to signed vectors.

In the paper by Attrapadung et al., the above scheme was proved unforgeable under a variant of the Diffie-Hellman assumption. This assumption posits that, given (g, ĝ, g^{a}, ĝ^{b})∈( × )², for randomly chosen a, b∈ ₚ and where ( , ) are cyclic bilinear group of order p, no Probabilistic Polynomial Time (PPT) algorithm can compute g^{ab}. In the version hereinbefore, the scheme is not completely context hiding (i.e., derived signatures are not statistically independent of original ones). Attrapadung et al. has shown how to modify the scheme so as to make it completely context hiding at the cost of increasing the signature length [see N. Attrapadung, B. Libert, T. Peters. Efficient Completely Context-Hiding Quotable Signatures and Linearly Homomorphic Signatures. In PKC'13, LNCS 7778, pp. 386-404, 2013].

The linearly homomorphic signatures in the prior art only exist for vector spaces where each vector's coordinates belong to a group, like ( ₚ, +), where it is easy to compute discrete logarithms. It will thus be appreciated that it is desired to have a scheme that can handle vectors \vec{M}₁∈ ⁿ whose coordinates live in a discrete-logarithm-hard group of finite order p. One major difficulty is that, in such groups, it is usually difficult to decide whether a plurality of vectors \vec{M}₁, . . . , \vec{M}ₙ₋₁∈ ⁿ are linearly dependent. In general, for n>2, the only known method to do this is to compute the discrete logarithms of all coordinates in ₚ.

It will thus be appreciated that it is desired to have a linearly homomorphic signature scheme where messages can be elements with a special algebraic structure, i.e. a “structure-preserving” signature scheme. The present invention provides such a scheme.

### SUMMARY OF INVENTION

In a first aspect, the invention is directed to a method for generating a linearly homomorphic signature σ on a vector (M₁, . . . , Mₙ)∈ ⁿ, wherein denotes a first group. A processor of a device computes, using a signing key sk={χᵢ, γᵢ, δᵢ}ᵢ₌₁ⁿ, signature elements (z, r, u) by calculating z=Πᵢ₌₁ⁿMᵢ^{-χ}^{ᵢ}, r=Πᵢ₌₁ⁿMᵢ^{-γ}^{ᵢ},

$$u = {\prod }_{i = 1}^{n} {M}_{i}^{- {δ}_{i}} ,$$

and outputs the signature σ comprising the signature elements (z, r, u).

In a preferred embodiment, the signing key further comprises an element

$${h}_{z}^{{α}_{r}} ,$$

the processor further chooses random elements θ,

$$ρ {←}^{ R } {ℤ}_{p} ;$$

calculates a further signature element v=h^{ρ}, wherein h is an element of a second group; wherein the calculation of z further comprises a multiplication by gᵣ^{θ}, the calculation of r further comprises a multiplication by g_{z}^{-θ} and the calculation of u further comprises a multiplication by

$${( {h}_{z}^{{α}_{r}} )}^{- θ} ,$$

wherein αᵣ is an integer and h, gᵣ and g_{z} are elements of the second group; wherein the signature further comprises the signature element v; and wherein the first group and the second group are the same.

In a second aspect, the invention is directed to a method of verifying a linearly homomorphic signature σ comprising signature elements (z, r, u) on a vector (M₁, . . . , Mₙ)∈ ⁿ, wherein denotes a first group. A processor of a device verifies that (M₁, . . . , Mₙ)≠( , . . . , ) and that (z, r, u) satisfy a first equality =e(g_{z}, z)·e(gᵣ, r)·Πᵢ₌₁ⁿe(gᵢ, Mᵢ) and a second equality =e(h_{z}, z)·e(h, u)·Πᵢ₌₁ⁿe(hᵢ, Mᵢ), wherein e(·, ·) denotes a symmetric and commutative pairing and wherein h, h_{z}, hᵢ, gᵣ, gᵢ and g_{z} are elements of a second group; and determines that the signature has been successfully verified in case the verifications are successful and that the signature has not been successfully verified otherwise.

In a first embodiment, the second equality further comprises a term e( (τ), v), wherein (τ) denotes a hash function and τ denotes an identifier of a subspace in which the signed vectors live.

In a third aspect, the invention is directed to a device for generating a linearly homomorphic signature σ on a vector (M₁, . . . , Mₙ)∈ ⁿ, wherein denotes a first group. The device comprises a processor configured to: compute, using a signing key sk={χᵢ, γᵢ, δᵢ}ᵢ₌₁ⁿ, signature elements (z, r, u) by calculating z=Πᵢ₌₁ⁿMᵢ^{-χ}^{ᵢ}, r=Πᵢ₌₁ⁿMᵢ^{-γ}^{ᵢ},

$$u = {\prod }_{i = 1}^{n} {M}_{i}^{- {δ}_{i}} ,$$

and output the signature σ comprising the signature elements (z, r, u).

In a first embodiment, the signing key further comprises an element

$${h}_{z}^{{α}_{r}} ,$$

the processor is further configured to: choose random elements θ,

$$ρ {←}^{ R } {ℤ}_{p} ;$$

and calculate a further signature element v=h^{ρ}, wherein h is an element of a second group; wherein the calculation of z further comprises a multiplication by gᵣ^{θ}, the calculation of r further comprises a multiplication by g_{z}^{-θ} and the calculation of u further comprises a multiplication by

$${( {h}_{z}^{{α}_{r}} )}^{- θ} ,$$

wherein αᵣ is an integer and h, gᵣ and g_{z} are elements of the second group; wherein the signature further comprises the signature element v; and wherein the first group and the second group are the same.

In a fourth aspect, the invention is directed to a device for verifying a linearly homomorphic signature σ comprising signature elements (z, r, u) on a vector (M₁, . . . , Mₙ)∈ ⁿ, wherein denotes a first group. The device comprises a processor configured to: verify that (M₁, . . . , Mₙ)≠( , . . . , ), and that (z, r, u) satisfy a first equality =e(g_{z}, z)·e(gᵣ, r)·Πᵢ₌₁ⁿe(gᵢ, Mᵢ) and a second equality =e(h_{z}, z)·e(h, u)·Πᵢ₌₁ⁿe(hᵢ, Mᵢ), wherein e(·, ·) denotes a symmetric and commutative pairing and wherein h, h_{z}, hᵢ, gᵣ, gᵢ and g_{z} are elements of a second group; and determine that the signature has been successfully verified in case the verifications are successful and that the signature has not been successfully verified otherwise.

In a first embodiment, the second equality further comprises a term e( (τ), v), wherein (τ) denotes a hash function and τ denotes an identifier of a subspace in which the signed vectors live.

In a fifth aspect, the invention is directed to a device for generating a linearly homomorphic signature σ on a vector (M₁, . . . , Mₙ)∈ ⁿ, wherein denotes a first group. The device comprises a processor configured to: compute, using a signing key

$$sk = {\{ {h}_{z}^{{α}_{r}} , {χ}_{i} , {γ}_{i} , {δ}_{i} \}}_{i = 1}^{n}$$

wherein h_{z} is a member of a second group and αᵣ is an integer, signature elements (z, r, u, v) by calculating

$$z = {g}_{r}^{θ} \cdot {\prod }_{i = 1}^{n} {M}_{i}^{- {χ}_{i}} , r = {g}_{z}^{- θ} \cdot {\prod }_{i = 1}^{n} {M}_{i}^{- {γ}_{i}} , u = {( {h}_{z}^{{α}_{r}} )}^{- θ} \cdot {\prod }_{i = 1}^{n} {M}_{i}^{- {δ}_{i}} , v = {h}^{ρ} ,$$

wherein (τ) denotes a hash function and τ denotes an identifier of a subspace in which the signed vectors live; generate commitments to z, r and u respectively; generate, using the commitments to z, r and u, proofs that z, r and u satisfy predetermined verification algorithms; and output the signature σ comprising the signature element v the commitments to z, r and u, and the proofs.

In a sixth aspect, the invention is directed to a device for verifying a linearly homomorphic signature σ on a vector (M₁, . . . , Mₙ)∈ ⁿ, wherein denotes a first group, the linearly homomorphic signature σ comprising a first signature element v, commitments \vec{C}_{z}, \vec{C}ᵣ, \vec{C}ᵤ to further signature elements z, r and u respectively, the commitments having been generated using vectors \vec{f}₁, \vec{f}₂, \vec{f}₃, and proofs \vec{π}₁, \vec{π}₂ that z, r and u satisfy predetermined verification algorithms. The device comprises a processor configured to: verify that (M₁, . . . , Mₙ)≠( , . . . , ) and that the verifications

$${\prod }_{i = 1}^{n} {E ( {g}_{i} , ( {1}_{𝔾} , {1}_{𝔾} , {M}_{i} ) )}^{- 1} = E ( {g}_{z} , {\vec{C}}_{z} ) \cdot ( {g}_{r} , {\vec{C}}_{r} ) \cdot E ( {π}_{1 , 1} , {\vec{f}}_{1} ) \cdot E ( {π}_{1 , 2} , {\vec{f}}_{2} ) \cdot E ( {π}_{1 , 3} , {\vec{f}}_{3} ) and$$

$${\prod }_{i = 1}^{n} {E ( {h}_{i} , ( {1}_{𝔾} , {1}_{𝔾} , {M}_{i} ) )}^{- 1} \cdot {E ( {H}_{𝔾} ( τ ) , ( {1}_{𝔾} , {1}_{𝔾} , v ) )}^{- 1} = E ( {h}_{z} , {\vec{C}}_{z} ) \cdot E ( h , {\vec{C}}_{u} ) .$$

E(π_{2,1}, \vec{f}₁)·E(π_{2,2}, \vec{f}₂)·E(π_{2,3}, \vec{f}₃), wherein E(·, ·) denotes a coordinate-wise pairing and wherein h, h_{z}, hᵢ, gᵣ, gᵢ and g_{z} are elements of a second group; and determine that the signature has been successfully verified in case the verifications are successful and that the signature has not been successfully verified otherwise.

### BRIEF DESCRIPTION OF DRAWINGS

Preferred features of the present invention will now be described, by way of non-limiting example, with reference to the accompanying drawings, in which:

FIG. 1 illustrates a structure-preserving linearly homomorphic signature system according to a preferred embodiment of the invention; and

FIG. 2 illustrates a method for generating and verifying context-hiding linearly homomorphic structure-preserving signatures according to a preferred embodiment of the invention.

### DESCRIPTION OF EMBODIMENTS

The structure-preserving linearly homomorphic signature scheme of the present invention is based on a modification of a structure-preserving signature scheme proposed in M. Abe, K. Haralambiev, M. Ohkubo. Signing on Elements in Bilinear Groups for Modular Protocol Design. Cryptology ePrint Archive: Report 2010/133, 2010 and in M. Abe, G. Fuchsbauer, J. Groth, K. Haralambiev, M. Ohkubo. Structure-Preserving Signatures and Commitments to Group Elements. In Crypto'10, Lecture Notes in Computer Science, vol. 6223, pp. 209-236, 2010 [see Appendix C of the first document for a description]. It will be appreciated that the scheme neither is nor was meant to be homomorphic and it only allows signing one message with respect to given public key.

A first modification is thus made so as to obtain a linearly homomorphic signature scheme over a discrete-logarithm-hard group as long as only one linear subspace (spanned by n−1 linearly independent vectors of ⁿ) is signed using a given key pair (sk; pk). This first scheme can be described as follows. In the following notations, pp denotes a set of public parameters consisting of groups ( _{T}) of prime order p>2^{λ}, where λ∈ is the security parameter, over which an efficiently computable bilinear map e: × → _{T} is defined.

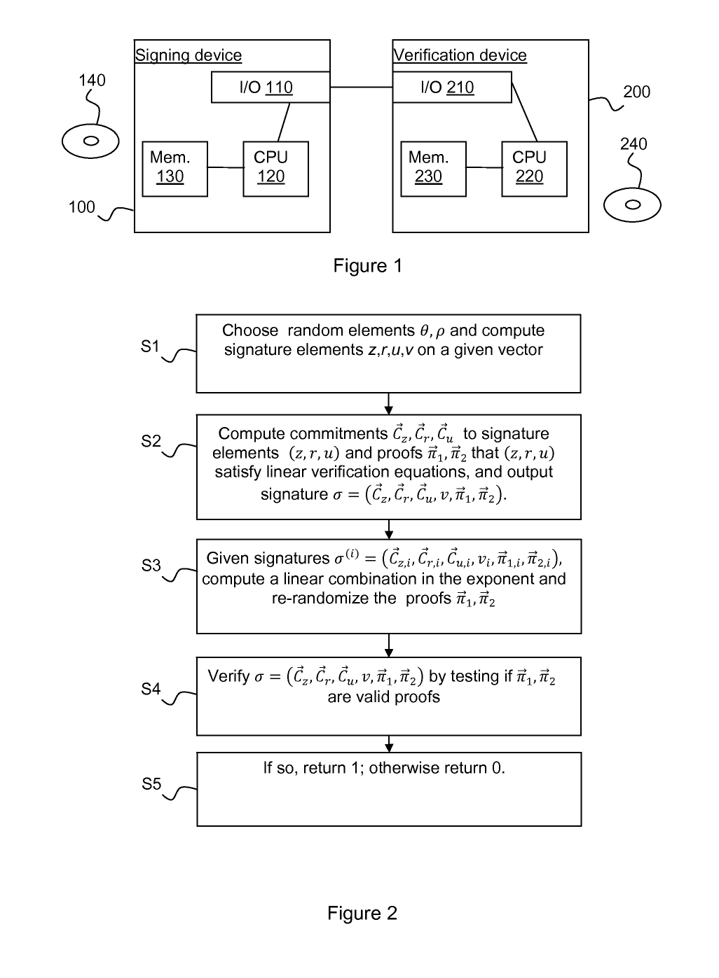

FIG. 1 illustrates a cryptographic signing device 100 for generating homomorphic signatures and a cryptographic signing device 200 for verification of homomorphic signatures according to a preferred embodiment of the invention. The devices 100, 200 each comprise at least one interface unit 110, 210 configured for communication, at least one processor (“processor”) 120, 220 and at least one memory 130, 230 configured for storing data, such as accumulators and intermediary calculation results. The Figure also shows a first and a second computer program product (non-transitory storage medium) 140, 240 such as a CD-ROM or a DVD comprises stored instructions that, when executed by the processor 120, 220, respectively generate and verify a signature according to the present invention.

### One-Time Scheme:

Keygen(pp, n): given pp and the dimension n∈ of the subspace to be signed, choose generators

$$h , {g}_{z} , {g}_{r} , {z}_{z} {←}^{ R } 𝔾 .$$

### Pick

$${χ}_{i} , {γ}_{i} , {δ}_{i} {←}^{ R } {ℤ}_{p}$$

for =1 to n. Then, for each ∈{1, . . . , n}, compute gᵢ=g_{z}^{χ}^{ᵢ}gᵣ^{γ}^{ᵢ}, hᵢ=h_{z}^{χ}^{ᵢ}h^{δ}^{ᵢ}. The public key is defined as

pk=(g_{z},hᵣ,h_{z},h,{gᵢ,hᵢ}ᵢ₌₁ⁿ)∈ ²ⁿ⁺⁴

and the private key as sk={χᵢ, γᵢ, δᵢ}ᵢ₌₁ⁿ.
Sign(sk, τ, (M₁, . . . , Mₙ)): to sign a vector (M₁, . . . , Mₙ)∈ ⁿ associated with the identifier τ=∈ using sk={χᵢ, γᵢ, δᵢ}ᵢ₌₁ⁿ, compute

$$z = {\prod }_{i = 1}^{n} {M}_{i}^{- {χ}_{i}} , r = {\prod }_{i = 1}^{n} {M}_{i}^{- {γ}_{i}} , u = {\prod }_{i = 1}^{n} {M}_{i}^{- {δ}_{i}} ,$$

The signature comprises σ=(z, r, u)∈^³.

### SignDerive

$$( pk , τ , {\{ ( {ω}_{i} , {σ}^{( i )} ) \}}_{i = 1}^{𝓁} ) \text{:}$$

given pk, a file identifier τ and l tuples (ωᵢ, σ⁽ⁱ⁾), parse each signature σ⁽ⁱ⁾ as σ⁽ⁱ⁾=(zᵢ, rᵢ, uᵢ)∈^³ for =1 to l. Compute

$$z = {\prod }_{i = 1}^{𝓁} {z}_{i}^{{ω}_{i}} r = {\prod }_{i = 1}^{𝓁} {r}_{i}^{{ω}_{i}} u = {\prod }_{i = 1}^{𝓁} {u}_{i}^{{ω}_{i}}$$

and return σ=(z, r, u).
Verify(pk, σ, τ, (M₁, . . . , Mₙ)): given a signature σ=(z, r, u)∈^³, a vector (M₁, . . . , Mₙ) and a file identifier τ=∈, return 1 if and only if (M₁, . . . , Mₙ)≠( , . . . , ) and (z, r, u) satisfy the equalities

=e(g_{z},z)·e(gᵣ,r)·Πᵢ₌₁ⁿe(gᵢ,Mᵢ), =e(h_{z},z)·e(h,u)·Πᵢ₌₁ⁿe(hᵢ,Mᵢ).

It can be proved that an adversary obtaining signatures on at most n−1 linearly independent vectors \vec{M}₁, . . . , \vec{M}ₙ₋₁ is unable to forge a signature on a vector \vec{M}∉ span(\vec{M}₁, . . . , \vec{M}ₙ₋₁) as long as the Simultaneous Double Pairing (SDP) assumption holds. The SDP assumption, described in the paper by Abe, Haralambiev and Ohkubo, is to, in ( ), given a tuple of elements (g_{z}, gᵣ, h_{z}, hᵤ)∈ ⁴, find a non-trivial tuple (z, r, u)∈^³\{( )} such that e(g_{z}·z)·e(gᵣ·r)= and e(h_{z}·z)·e(hᵤ·u)= .

### Full-Fledged Scheme:

The one-time scheme can be upgraded to a linear construction allowing to sign an arbitrary number of linear subspaces. To do this, a configuration of bilinear groups ( ) for which =^ is needed. In other words, the bilinear map e: × → _{T} must have both of its arguments in the same group because it should be symmetric and commutative.

In the construction, each file identifier T consists of a L-bit string, for some L∈poly(λ). The u component of each signature can be seen as an aggregation of the signature of the one-time scheme with a Waters signature (h_{z}^{α}^{ᵣ}· (τ)^{-ρ}, h^{ρ}) on the file identifier τ [see B. Waters. Efficient Identity-Based Encryption Without Random Oracles. In Eurocrypt'05, Lecture Notes in Computer Science, vol. 3494, pp. 114-127, 2005]. In the present scheme, such a Waters signature is used as a support for a signature randomizer θ∈ ₚ.

Keygen(pp, n): given pp and the dimension n∈ of the subspace to be signed, perform the following steps:
1. Choose

$$h {←}^{ R } 𝔾 and {α}_{z} , {α}_{r} , {β}_{z} {←}^{ R } {ℤ}_{p} .$$

Define g_{z}=h^{α}^{_{z}}, gᵣ=h^{α}^{ᵣ} and h_{z}=h^{β}^{_{z.}}
2. For =1 to n, pick

$${χ}_{i} , {γ}_{i} , {δ}_{i} {←}^{ R } {ℤ}_{p}$$

and compute gᵢ=g_{z}^{χ}^{ᵢ}gᵣ^{γ}^{ᵢ}, hᵢ=h_{z}^{χ}^{ᵢ}h^{δ}^{_{i.}}
3. Choose a random vector

$$\overline{w} = ( {w}_{0} , {w}_{1} , … , {w}_{L} ) {←}^{ R } {𝔾}^{L + 1}$$

that defines a hash function : {0,1}^{L}→ which maps τ=τ[1] . . . τ[L]∈{0,1}^{L} to (τ)=w₀·Πₖ₌₁^{L}wₖ^{τ[k]}.

The public key consists of

pk=(g_{z},gᵣ,h_{z},h,{gᵢ,hᵢ}ᵢ₌₁ⁿ, w̅)∈ ²ⁿ⁺⁴× ^{L+1}

while the private key is

$$sk = ( {h}_{z}^{{α}_{r}} , {\{ {χ}_{i} , {γ}_{i} , {δ}_{i} \}}_{i = 1}^{n} ) .$$

Sign(sk, τ, (M₁, . . . , Mₙ)): to sign a vector (M₁, . . . , Mₙ)∈ ⁿ with regard to the file identifier τ using

$$sk = ( {h}_{z}^{{α}_{r}} , {\{ {χ}_{i} , {γ}_{i} , {δ}_{i} \}}_{i = 1}^{n} ) ,$$

choose θ,

$$ρ {←}^{ R } {ℤ}_{p}$$

and compute

$$z = {g}_{r}^{θ} \cdot {\prod }_{i = 1}^{n} {M}_{i}^{- {χ}_{i}} , r = {g}_{z}^{- θ} \cdot {\prod }_{i = 1}^{n} {M}_{i}^{- {γ}_{i}} , u = {( {h}_{z}^{{α}_{r}} )}^{- θ} \cdot {\prod }_{i = 1}^{n} {M}_{i}^{- {δ}_{i}} \cdot {{H}_{𝔾} ( τ )}^{- ρ} , v = {h}^{ρ} ,$$

The signature comprises σ=(z, r, u, v)∈ ⁴.

### SignDerive

$$( pk , τ , {\{ ( {ω}_{i} , {σ}^{( i )} ) \}}_{i = 1}^{𝓁} ) \text{:}$$

given pk, a file identifier τ and l tuples (ωᵢ, σ⁽ⁱ⁾), parse each signature σ⁽ⁱ⁾ as σ⁽ⁱ⁾=(zᵢ, rᵢ, uᵢ, vᵢ)∈ ⁴ for =1 to l. Then choose

$${ρ}^{′} {←}^{ R } {ℤ}_{p}$$

and compute

$$z = {\prod }_{i = 1}^{𝓁} {z}_{i}^{{ω}_{i}} r = {\prod }_{i = 1}^{𝓁} {r}_{i}^{{ω}_{i}} u = {\prod }_{i = 1}^{𝓁} {u}_{i}^{{ω}_{i}} \cdot {{H}_{𝔾} ( τ )}^{- {ρ}^{′}} v = {\prod }_{i = 1}^{𝓁} {v}_{i}^{{ω}_{i}} \cdot {h}^{{ρ}^{′}}$$

and return σ=(z, r, u, v).
Verify(pk, σ, τ, (M₁, . . . , Mₙ)): given a signature σ=(z, r, u, v)∈ ⁴, a file identifier τ and a vector (M₁, . . . , Mₙ), return 1 if and only if (M₁, . . . , Mₙ)≠( , . . . , ) and (z, r, u, v) satisfy the equalities

$${1}_{{𝔾}_{T}} = e ( {g}_{z} , z ) \cdot e ( {g}_{r} , r ) \cdot {\prod }_{i = 1}^{n} e ( {g}_{i} , {M}_{i} ) , \\ {1}_{{𝔾}_{T}} = e ( {h}_{z} , z ) \cdot e ( h , u ) \cdot e ( {H}_{𝔾} ( τ ) , v ) \cdot {\prod }_{i = 1}^{n} e ( {h}_{i} , {M}_{i} ) .$$

It will be appreciated that the one-time scheme is a special case of the full-fledged scheme where 0=p=0 in each signature.

### Context-Hiding Scheme:

It will be appreciated that the full-fledged scheme does not provide complete context-hiding security because the signature derivation operation cannot re-randomize the underlying θ without knowing the private key. In some applications it may be desirable to make sure that derived signatures and original ones are unlinkable, even in the view of a computationally unbounded observer.

For this reason, the preferred embodiment is a scheme that can be proved completely context-hiding. This scheme is obtained by modifying the full-fledged scheme. Essentially, the signer first computes a signature σ=(z, r, u, v) as in the full-fledged scheme. Since elements (z, r, u) cannot be publicly re-randomized, the signer only lets them appear within Groth-Sahai commitments [see J. Groth, A. Sahai. Efficient non-interactive proof systems for bilinear groups. In Eurocrypt'08, Lecture Notes in Computer Science, vol. 4965, pp. 415-432, 2008.] and adds a non-interactive proof that committed values satisfy the verification equations. The perfect randomizability properties (shown in M. Belenkiy, J. Camenisch, M. Chase, M. Kohlweiss, A. Lysyanskaya, H. Shacham. Randomizable Proofs and Delegatable Anonymous Credentials. In Crypto'09, Lecture Notes in Computer Science, vol. 5677, pp. 108-125, 2009.) of Groth-Sahai proofs guarantee that derived signatures will be distributed as freshly generated signatures.

In the following description, it is again required that the bilinear map e: × > _{T} is symmetric (i.e. = ). In the following notations, a coordinate-wise pairing E: × ³→ _{T}³ is defined such that, for any element h∈ and any vector \vec{g}=(g₁, g₂, g₃), E(h, \vec{g})=(e(h, g₁), e(h, g₂), e(h, g₃)).

FIG. 2 illustrates Sign, SignDerive and Verify of the following scheme.

Keygen(pp, n): given pp and the dimension n∈ of the subspace to be signed, perform the following steps:
1. Choose

$$h {←}^{ R } 𝔾 and {α}_{z} , {a}_{r} , {β}_{z} {←}^{ R } {ℤ}_{p} .$$

Define g_{z}=h^{α}^{_{z}}, gᵣ=h^{α}^{ᵣ} and h_{z}=h^{β}^{_{z.}}
2. For each ∈{1, . . . n}, pick

$${χ}_{i} , {γ}_{i} , {δ}_{i} {←}^{ R } {ℤ}_{p}$$

and compute gᵢ=g_{z}^{χ}^{ᵢ}gᵣ^{γ}^{ᵢ}, hᵢ=h_{z}^{χ}^{ᵢ}h^{δ}^{_{i.}}
3. Choose a Groth-Sahai common reference string by choosing

$${f}_{1} , {f}_{2} {←}^{ R } 𝔾$$

and defining vectors \vec{f₁}=(f₁, 1, g)∈ ³, \vec{f₂}=(1, f₂, g)∈ ³ and

$${\vec{f}}_{3} {←}^{ R } {𝔾}^{3} .$$

The public key consists of

pk=(g_{z},gᵣ,h_{z},h,{gᵢ,hᵢ}ᵢ₌₁ⁿ,f=(\vec{f₁}, \vec{f₂}, \vec{f₃}))

while the private key is sk=(h_{z}^{α}^{_{r, {χ}}ᵢ, γᵢ, δᵢ}ᵢ₌₁ⁿ).
Sign(sk, τ, (M₁, . . . , Mₙ)): to sign a vector (M₁, . . . , Mₙ)∈ ⁿ with regard to the file identifier τ using

$$sk = ( {h}_{z}^{{α}_{r}} , {\{ {χ}_{i} , {γ}_{i} , {δ}_{i} \}}_{i = 1}^{n} ) ,$$

perform:
1. Choose S1 θ,

$$ρ {←}^{ R } {ℤ}_{p}$$

and compute

$$z = {g}_{r}^{θ} \cdot {\prod }_{i = 1}^{n} {M}_{i}^{- {χ}_{i}} , r = {g}_{z}^{- θ} \cdot {\prod }_{i = 1}^{n} {M}_{i}^{- {γ}_{i}}$$

$$u = {( {h}_{z}^{{α}_{r}} )}^{- θ} \cdot {\prod }_{i = 1}^{n} {M}_{i}^{- {δ}_{i}} \cdot {{H}_{𝔾} ( τ )}^{- ρ} , v = {h}^{ρ}$$

2. Using the vectors f=(\vec{f₁}, \vec{f₂}, \vec{f₃}), compute S2 commitments

$${\vec{C}}_{z} = ( {1}_{𝔾} , {1}_{𝔾} , z ) \cdot {\vec{f}}_{1}^{{v}_{z , 1}} \cdot {\vec{f}}_{2}^{{v}_{z , 2}} \cdot {\vec{f}}_{3}^{{v}_{z , 3}}$$

$${\vec{C}}_{r} = ( {1}_{𝔾} , {1}_{𝔾} , r ) \cdot {\vec{f}}_{1}^{{v}_{r , 1}} \cdot {\vec{f}}_{2}^{{v}_{r , 2}} \cdot {\vec{f}}_{3}^{{v}_{r , 3}}$$

$${\vec{C}}_{u} = ( {1}_{𝔾} , {1}_{𝔾} , u ) \cdot {\vec{f}}_{1}^{{v}_{u , 1}} \cdot {\vec{f}}_{2}^{{v}_{u , 2}} \cdot {\vec{f}}_{3}^{{v}_{z , 3}}$$

to z, r and u, respectively. Using the randomness of these commitments, generate proofs \vec{π}₁=(π_{1,1}, π_{1,2}, π_{1,3})∈ ³ and \vec{π}₂=(π_{2,1}, π_{2,2}, π_{2,3})∈ ³ that (z, r, u) satisfy the verification equations of the full-fledged scheme, i.e.

$${1}_{{𝔾}_{T}} = e ( {g}_{z} , z ) \cdot e ( {g}_{r} , r ) \cdot {\prod }_{i = 1}^{n} e ( {g}_{i} , {M}_{i} ) , \\ {1}_{{𝔾}_{T}} = e ( {h}_{z} , z ) \cdot e ( h , u ) \cdot e ( {H}_{𝔾} ( τ ) , v ) \cdot {\prod }_{i = 1}^{n} e ( {h}_{i} , {M}_{i} ) .$$

These proofs are obtained as

$${\vec{π}}_{1} = ( {π}_{1 , 1} , {π}_{1 , 2} , {π}_{1 , 3} ) = ( {g}_{z}^{- {v}_{z , 1}} \cdot {g}_{r}^{- {v}_{r , 1}} , {g}_{z}^{- {v}_{z , 2}} \cdot {g}_{r}^{- {v}_{r , 2}} , {g}_{z}^{- {v}_{z , 3}} \cdot {g}_{r}^{- {v}_{r , 3}} )$$

$${\vec{π}}_{1} = ( {π}_{2 , 1} , {π}_{2 , 2} , {π}_{2 , 3} ) = ( {h}_{z}^{- {v}_{z , 1}} \cdot {h}_{r}^{- {v}_{u , 1}} , {h}_{z}^{- {v}_{z , 2}} \cdot {h}_{r}^{- {v}_{u , 2}} , {h}_{z}^{- {v}_{z , 3}} \cdot {h}_{r}^{- {v}_{u , 3}} )$$

and satisfy the verification equations

$${\prod }_{i = 1}^{n} {E ( {g}_{i} , ( {1}_{𝔾} , {1}_{𝔾} , {M}_{i} ) )}^{- 1} = E ( {g}_{z} , {\vec{C}}_{z} ) \cdot E ( {g}_{r} , {\vec{C}}_{r} ) \cdot E ( {π}_{1 , 1} , {\vec{f}}_{1} ) \cdot E ( {π}_{1 , 2} , {\vec{f}}_{2} ) \cdot E ( {π}_{1 , 3} , {\vec{f}}_{3} )$$

$${\prod }_{i = 1}^{n} {E ( {h}_{i} , ( {1}_{𝔾} , {1}_{𝔾} , {M}_{i} ) )}^{- 1} \cdot {E ( {H}_{𝔾} ( τ ) , ( {1}_{𝔾} , {1}_{𝔾} , v ) )}^{- 1} = E ( {h}_{z} , {\vec{C}}_{z} ) \cdot E ( h , {\vec{C}}_{u} ) \cdot E ( {π}_{2 , 1} , {\vec{f}}_{1} ) \cdot E ( {π}_{2 , 2} , {\vec{f}}_{2} ) \cdot E ( {π}_{2 , 3} , {\vec{f}}_{3} )$$

The signature comprises σ=(\vec{C}_{z}, \vec{C}ᵣ, \vec{C}ᵤ, v, \vec{π}₁, \vec{π}₂)∈ ¹⁶.

SignDerive(pk, τ, {(ωᵢ, σ⁽ⁱ⁾)}ᵢ₌₁^{l}): given pk, a file identifier τ and l tuples (ωᵢ, σ⁽ⁱ⁾), parse each signature σ⁽ⁱ⁾ as a tuple of the form σ⁽ⁱ⁾=(\vec{C}_{z,i}, \vec{C}_{r,i}, \vec{C}_{u,i}, v, \vec{π}_{1,i}, \vec{π}_{2,i})∈ ¹⁶ for =1 to l. Choose

$${ρ}^{′} {←}^{ R } {ℤ}_{p}$$

and compute

$${\vec{C}}_{z} = {\prod }_{i = 1}^{𝓁} {\vec{C}}_{z , i}^{{ω}_{i}} {\vec{C}}_{r} = {\prod }_{i = 1}^{𝓁} {\vec{C}}_{r , i}^{{ω}_{i}} {\vec{C}}_{u} = {\prod }_{i = 1}^{𝓁} {\vec{C}}_{u , i}^{{ω}_{i}} \cdot {{H}_{𝔾} ( τ )}^{- {ρ}^{′}}$$

$$v = {\prod }_{i = 1}^{𝓁} {v}_{i}^{{ω}_{i}} \cdot {h}^{{ρ}^{′}} {\vec{π}}_{1} = {\prod }_{i = 1}^{𝓁} {π}_{1 , i}^{{ω}_{i}} {\vec{π}}_{2} = {\prod }_{i = 1}^{𝓁} {π}_{2 , i}^{{ω}_{i}}$$

Then S3 re-randomize the commitments and proofs and return σ=(\vec{C}_{z}, \vec{C}ᵣ, \vec{C}ᵤ, v, \vec{π}₁, \vec{π}₂).

Verify(pk, σ, τ, (M₁, . . . , Mₙ)): given a pair (τ, (M₁, . . . Mₙ)) and a purported signature σ, parse the signature as (\vec{C}_{z}, \vec{C}ᵣ, \vec{C}ᵤ, v, \vec{π}₁, \vec{π}₂). Then, S5 return 1 if and only if (M₁, . . . , Mₙ)≠( , . . . , ) and the Sign verifications are satisfied S4, i.e.

$${\prod }_{i = 1}^{n} {E ( {g}_{i} , ( {1}_{𝔾} , {1}_{𝔾} , {M}_{i} ) )}^{- 1} = E ( {g}_{z} , {\vec{C}}_{z} ) \cdot E ( {g}_{r} , {\vec{C}}_{r} ) \cdot E ( {π}_{1 , 1} , {\vec{f}}_{1} ) \cdot E ( {π}_{1 , 2} , {\vec{f}}_{2} ) \cdot E ( {π}_{1 , 3} , {\vec{f}}_{3} )$$

$${\prod }_{i = 1}^{n} {E ( {h}_{i} , ( {1}_{𝔾} , {1}_{𝔾} , {M}_{i} ) )}^{- 1} \cdot {E ( {H}_{𝔾} ( τ ) , ( {1}_{𝔾} , {1}_{𝔾} , v ) )}^{- 1} = E ( {h}_{z} , {\vec{C}}_{z} ) \cdot E ( h , {\vec{C}}_{u} ) \cdot E ( {π}_{2 , 1} , {\vec{f}}_{1} ) \cdot E ( {π}_{2 , 2} , {\vec{f}}_{2} ) \cdot E ( {π}_{2 , 3} , {\vec{f}}_{3} )$$

The unforgeability of the scheme can be proved under the Decision Linear assumption, which informally says that it is infeasible to decide whether three vectors of group elements of dimension 3 are linearly dependent or not. Moreover, the scheme is unconditionally context-hiding.

The advantage of the present invention is that it can allow a signer to sign vectors consisting of group elements without knowing their discrete logarithms. For example, the signature schemes make it possible for the signer to sign ciphertexts without necessarily knowing the underlying plaintext.

It will be appreciated that the schemes of the present invention can be used to outsource encrypted datasets in cloud computing services. In addition, linearly homomorphic signatures can also serve as proofs of correct aggregation in anonymous recommendation systems.

Each feature disclosed in the description and (where appropriate) the claims and drawings may be provided independently or in any appropriate combination. Features described as being implemented in hardware may also be implemented in software, and vice versa. Reference numerals appearing in the claims are by way of illustration only and shall have no limiting effect on the scope of the claims.

1. A method of generating a linearly homomorphic signature σ on a vector (M₁, . . . , Mₙ)∈ ⁿ, wherein denotes a first group, the method comprising in a processor of a device:
computing, using a signing key sk={χᵢ, γᵢ, δᵢ}ᵢ₌₁ⁿ, signature elements (z, r, u) by calculating
$$z = {\prod }_{i = 1}^{n} {M}_{i}^{- {χ}_{i} } , r = {\prod }_{i = 1}^{n} {M}_{i}^{- {γ}_{i}} , u = {\prod }_{i = 1}^{n} {M}_{i}^{- {δ}_{i}} ,$$
and
outputting the signature σ comprising the signature elements (z, r, u).

2. The method of claim 1, wherein the signing key further comprises an element
$${h}_{z}^{{α}_{r}} ,$$
the method further comprising:
choosing random elements θ,
$$ρ {←}^{ R } {ℤ}_{p} ;$$
calculating a further signature element v=h^{ρ}, wherein h is an element of a second group;
wherein the calculation of z further comprises a multiplication by gᵣ^{θ}, the calculation of r further comprises a multiplication by g_{z}^{-θ} and the calculation of u further comprises a multiplication by
$${( {h}_{z}^{{α}_{r}} )}^{- θ} ,$$
wherein αᵣ is an integer of h, gᵣ and g_{z} are elements of the second group;
wherein the signature further comprises the signature element v; and
wherein the first group and the second group are the same.

3. A method of verifying a linearly homomorphic signature σ comprising signature elements (z, r, u) on a vector (M₁, . . . , Mₙ)∈ ⁿ, wherein denotes a first group, the method comprising in a processor of a device:
verifying that (M₁, . . . , Mₙ)≠( , . . . , ) and that (z, r, u) satisfy a first equality
=e(g_{z},z)·e(gᵣ,r)·Πᵢ₌₁ⁿe(gᵢ,Mᵢ) and a second equality =e(h_{z},z)·e(h,u)·Πᵢ₌₁ⁿe(hᵢ,Mᵢ),
wherein e(·, ·) denotes a symmetric and commutative pairing and wherein h, h_{z}, hᵢ, gᵣ, gᵢ and g_{z} are elements of a second group; and
determining that the signature has been successfully verified in case the verifications are successful and that the signature has not been successfully verified otherwise.

4. The method of claim 3, wherein the second equality further comprises a term e( (τ), v), wherein (τ) denotes a hash function and τ denotes an identifier of a subspace in which the signed vectors live.

5. A device for generating a linearly homomorphic signature σ on a vector (M₁, . . . , Mₙ)∈ ⁿ, wherein denotes a first group, the device comprising a processor configured to:
compute, using a signing key sk={χᵢ, γᵢ, δᵢ}ᵢ₌₁ⁿ, signature elements (z, r, u) by calculating
$$z = {\prod }_{i = 1}^{n} {M}_{i}^{- {χ}_{i} } , r = {\prod }_{i = 1}^{n} {M}_{i}^{- {γ}_{i}} , u = {\prod }_{i = 1}^{n} {M}_{i}^{- {δ}_{i}} ,$$
and
output the signature σ comprising the signature elements (z, r, u).

6. The device of claim 5, wherein the signing key further comprises an element
$${h}_{z}^{{α}_{r}} ,$$
the processor is further configured to:
choose random elements θ,
$$ρ {←}^{ R } {ℤ}_{p} ;$$
and
calculate a further signature element v=h^{ρ}, wherein h is an element of a second group;
wherein the calculation of z further comprises a multiplication by gᵣ^{θ}, the calculation of r further comprises a multiplication by g_{z}^{-θ} and the calculation of u further comprises a multiplication by
$${( {h}_{z}^{{α}_{r}} )}^{- θ} ,$$
wherein αᵣ is an integer and h, gᵣ and g_{z} are elements of the second group;
wherein the signature further comprises the signature element v; and
wherein the first group and the second group are the same.

7. A device for verifying a linearly homomorphic signature σ comprising signature elements (z, r, u) on a vector (M₁, . . . , Mₙ)∈ ⁿ, wherein denotes a first group, the device comprising a processor configured to:
verify that (M₁, . . . , Mₙ)≠( , . . . , ) and that (z, r, u) satisfy a first equality
=e(g_{z},z)·e(gᵣ,r)·Πᵢ₌₁ⁿe(gᵢ,Mᵢ) and a second equality =e(h_{z},z)·e(h,u)·Πᵢ₌₁ⁿe(hᵢ,Mᵢ),
wherein e(·, ·) denotes a symmetric and commutative pairing and wherein h, h_{z}, hᵢ, gᵣ, gᵢ and g_{z} are elements of a second group; and
determine that the signature has been successfully verified in case the verifications are successful and that the signature has not been successfully verified otherwise.

8. The device of claim 7, wherein the second equality further comprises a term e( (τ), v), wherein (τ) denotes a hash function and τ denotes an identifier of a subspace in which the signed vectors live.

9. A device for generating a linearly homomorphic signature σ on a vector (M₁, . . . , Mₙ)∈ ⁿ, wherein denotes a first group, the device comprising processor configured to:
compute, using a signing key
$$sk = {\{ {h}_{z}^{{α}_{r}} , {χ}_{i} , {γ}_{i} , {δ}_{i} \}}_{i = 1}^{n}$$
wherein h_{z} is a member of a second group and αᵣ is an integer, signature elements (z, r, u, v) by calculating
$$z = {g}_{r}^{θ} \cdot {\prod }_{i = 1}^{n} {M}_{i}^{- {χ}_{i}} , r = {g}_{z}^{- θ} \cdot {\prod }_{i = 1}^{n} {M}_{i}^{- {γ}_{i}} , u = {( {h}_{z}^{{α}_{r}} )}^{- θ} \cdot {\prod }_{i = 1}^{n} {M}_{i}^{- {δ}_{i}} , v = {h}^{ρ} ,$$
wherein (τ) denotes a hash function and τ denotes an identifier of a subspace in which the signed vectors live;
generate commitments to z, r and u respectively;
generate using the commitments to z, r and u, proofs that z, r and u satisfy predetermined verification algorithms; and
output the signature σ comprising the signature element v the commitments to z, r and u, and the proofs.

10. A device for verifying a linearly homomorphic signature σ on a vector (M₁, . . . , Mₙ)∈ ⁿ, wherein denotes a first group, the linearly homomorphic signature σ comprising a first signature element v, commitments \vec{C}_{z}, \vec{C}ᵣ, \vec{C}ᵤ to further signature elements z, r and u respectively, the commitments having been generated using vectors \vec{f}₁, \vec{f}₂, \vec{f}₃, and proofs \vec{π}₁, \vec{π}₂ that z, r and u satisfy predetermined verification algorithms, the device comprising a processor configured to:
verify that (M₁, . . . , Mₙ)≠( , . . . , ) and that the verifications Πᵢ₌₁ⁿE(gᵢ, ( , , Mᵢ))⁻¹=E(g_{z}, \vec{C}_{z})·E(gᵣ, \vec{C}ᵣ)·E (π_{1,1}, \vec{f}₁)·E(π_{1,2}, \vec{f}₂)·E(π_{1,3}, \vec{f}₃) and Πᵢ₌₁ⁿE(hᵢ, ( , , Mᵢ))⁻¹·E( (τ), ( , v))⁻¹=E(h_{z}, \vec{C}_{z})·E(h, \vec{C}ᵤ)·E(π_{2,1}, \vec{f}₁)·E (π_{2,2}, \vec{f}₂)·E (π_{2,3}, \vec{f}₃),
wherein E(·, ·) denotes a coordinate-wise pairing and wherein h, h_{z}, hᵢ, gᵣ, gᵢ and g_{z} are elements of a second group; and
determine that the signature has been successfully verified in case the verifications are successful and that the signature has not been successfully verified otherwise.
